(19) United States
(12) Patent Application Publication
(10) Pub. No.: US 2025/0391392 A1
(43) Pub. Date: Dec. 25, 2025

(54) ACOUSTIC GUITAR PICKUP, TRANSDUCER, AND METHOD FOR MANUFACTURING SAME

(71) Applicant: EMFIT Ltd., Vaajakoski (FI)

(72) Inventor: Heikki RÄISÄNEN, Vaajakoski (FI)

(73) Assignee: EMFIT Ltd., Vaajakoski (FI)

(21) Appl. No.: 19/225,998

(22) Filed: Jun. 2, 2025

Related U.S. Application Data
(60) Provisional application No. 63/654,904, filed on May 31, 2024.

(51) Int. Cl. G10H 3/18

(52) U.S. Cl. CPC G10H 3/181

(57) ABSTRACT

A pickup for converting string vibrations from a vibrating musical instrument into electrical signals has a structure the structure being unitary, flexible, and laminated and extending seamlessly from a transducer through a connector to a contact; the structure having a substrate, the substrate having an electromechanical film; the transducer being printed on the electromechanical film; the connector being printed on the electromechanical film and operatively connecting the transducer to the contact.

### CROSS-REFERENCE TO RELATED APPLICATIONS

This application claims priority from provisional patent application U.S. Ser. No. 63/654,904, filed on May 31, 2024, which is pending, and which is incorporated by reference in its entirety for all purposes.

### BACKGROUND OF THE INVENTION

### Field of the Invention

The present invention is directed to a transducer and a pickup for an acoustic guitar.

More particularly, the present invention is directed to a flexible, unitary ferroelectret film transducer for converting vibrations of acoustic guitar strings and body vibrations of such guitars into electric signals, and to a method for its fabrication.

Even more particularly, the invention is directed to a pickup that when used in an acoustic guitar is attached with an adhesive into a saddle plate inside the guitar.

The invention is also directed to a pickup that is installed under the saddle into the saddle slot, between the saddle and the saddle slot bottom.

### Discussion of the Related Art

Transducers, especially contact transducers, are commonly used in certain types of musical instruments for capturing or sensing an instrument's vibrations. That is, an instrument's vibration is picked up. Accordingly, while engineers talk about transducers capturing vibrations, musicians talk about pickups that capture the sound of their instrument.

When heard by a listener, the vibrations of the instruments create sound waves that are the perceived sound of the instrument. In the transducer, however, the instrument's vibration are captured as an electrical signal that is amplified using an instrument amplifier. The amplifier in turn produces air vibrations through a loudspeaker that is the musical sounds of the instruments. The electrical signal from a transducer can also be recorded directly on a storage media such as magnetic tape, i.e. cassettes, or on hard drive or solid state drives.

The invention is applicable for use in many types acoustic musical string instruments such as guitars, ukuleles, violins, basses, and in percussion instruments such as drum sets, tambourine, cajons (a box shaped percussion instrument), membranophones, and idiophones. These lists are only exemplary and are intended to be exhaustive since the variety and ingenuity of making music leads to many new and interesting stringed and percussion instruments.

Herein, the terms “transducer” and “pickup” are not necessarily synonymous. The term “transducer” is used for a physical electromechanical element that converts vibrations. A “pickup” is used for an object having a form factor suitable for the musical instrument with which it is associated and includes at least one transducer, but more often also includes one or more connectors and one or more connections from the transducer to the respective connector.

The pickup is usually positioned onto a vibrating member. In an acoustic guitar, the preferred location is typically the top, inside the instrument, and, herein, this location is referred to as the musician preferred location or “MPL.” The pickup is attached by using an adhesive, for example an acrylic adhesive 50 microns in thickness. Such an adhesive is made by several manufacturers, for example by 3M® and Nitto Denko Corporation.

Pickups can alternatively be positioned between the saddle and the saddle slot for alternative pickup configurations.

Acoustic guitar contact pickups, when affixed with adhesive onto the guitar top beneath the saddle area, are engineered to convert vibrations from both the strings and the wooden top into electrical signals. Typically, these pickups comprise an active transducer element, housing one or more layers of electromechanical transducer materials.

The acoustic guitar contact pickup also includes electrically conductive electrode layers that are interspersed with dielectric material, and further also a connection cable segment facilitating the transmission of the electrical signal to a signal preamplifier. In an acoustic guitar this preamplifier is commonly situated within the guitar body in place of the end pin. The primary function of the preamplifier is to convert the inherently high impedance signal into a low impedance one, while also performing band-pass filtering and amplification to render it more compatible with main amplifiers or audio recorders. Additionally, the preamplifier may incorporate electronics for analog-to-digital conversion and wireless transmission.

In the most common pickup configurations, the connection cable segment typically employs screened coaxial cable, which is soldered to the electrode layers of the transducer component. Such a transducer design is exemplified, for instance, in U.S. Pat. No. 5,319,153.

Typically, the construction of the transducer comprises electromechanical transducer elements which typically are one or more piezo-ceramic (PZT) disks, or piezoelectric film (e.g., polyvinylidene fluoride, PVDF), or cellular, swelled, permanently charged, electret film. The prior art of contact pickups uses, piezoelectric crystals, piezoelectric film permanently charged cellular ferroelectret film.

A typical drawback of electromechanical transducer elements lies in the complexity of transducer fabrication and the associated relatively high manufacturing costs, since much of the assembly process necessitates manual labor. Additionally, prior art structures often feature separate transducer components and connection cables, requiring connections to the preamplifier to be established either via soldering or through the use of a miniplug soldered onto the cable. This manual labor results in increased production costs.

Another prior art solution is detailed in U.S. Pat. No. 6,689,948 B2. This solution entails the fabrication of acoustic guitar pickups through a process involving screen-printing the necessary electrodes onto sheets of dielectric film (such as polyester) and/or directly onto a cellular electret film.

In the screen-printing process, multiple electrodes are positioned side by side on the same sheet. The assembly process involves laminating these sheets and dielectric cellular electret film together, ensuring that the charged dielectric cellular electret film is selectively placed only on a desired area at one end of the sheet, while the other end features a connector part with different electrode layers arranged side by side. This lamination process yields a laminate sheet from which transducers can be cut out by, for example, by punching. Subsequently, a suitable connector, such as Crimpflex™ offered by manufacturer NICOMATIC®, is mechanically crimped to the electrodes at the connector end of the transducer.

Weight is a major drawback of prior art contact pickups. Acoustic guitars' sound may be affected by anything that is attached into its top. That is when the pickup is located at the MPL, the weight may adversely affect the resultant instrument sound.

Regarding under saddle pickups, thickness and poor string balance are also common drawbacks of prior art pickups.

Thus, what is desired is a pickup for attaching to the inside of a stringed instrument, onto the top of the stringed instrument guitar top, at the saddle plate, that is as light as possible. More particularly, what is desired is a contact type pickup for attaching to the inside of a guitar, onto guitar top, at the saddle plate, that is as light as possible.

Other major drawbacks of the prior art pickups are, for example U.S. Pat. No. 6,689,948 B2, their complicated manufacturing process. In it, materials are handled several times before a laminate is ready for die-cutting as the design involves several sheets laminating together, which means more materials, including adhesives, and handwork, than is today economically possible for the end value of a ready product. Typically, one manufacturer has machinery for manufacturing charged electret material and laminations, and another is capable to screen-printing and die- or laser-cutting. In the mentioned prior-art patent, is mentioned also a method of printing electrodes directly onto cellular charged film. However, it is learned that such is not truly possible in practice as the polypropylene based, biaxially oriented and swelled electret material is very fragile. Especially problematic is the temperature needed for curing printed silver paste, it being about 80 C degrees at minimum. In that temperature the pp-based material is shrinking causing impossible to print electrodes on both sides as opposite sides printing cannot be aligned/matched in the needed tolerance. Without perfectly aligned printing, the problem comes with electromagnetic noise (50 Hz/60 Hz) as well shorts in the edges, after cutting into individual pickups. A major problem also comes that the pp-based material alone is so thin and fragile that printed electrodes would too easily get wrinkles causing significant resistance between signal area picking vibrations and crimped contact taking the sound further to signal preamplifier.

One drawback of prior art contact transducers using ferro electret cellular film is its (prior art) manufacturing process. The problem is the accumulation of charges in the reel-to-reel DC charging process. When wound layers increase, the charges accumulate and cause discharge through the layers. The result is that there appear areas without any charges or even possibly opposite charges.

This is a severe quality issue in the final product and difficult to detect before electrodes are printed and sheets are die-cut into individual pickups, which are also crimped. Hence the quality problem, unwanted discharges at the reel-to-reel charging, can cause severe economic losses.

As explained in U.S. Pat. No. 6,689,948, a dielectric cellular or porous electret film, along with its manufacturing process, applicable for use as a transducer in stringed musical instruments, is described in U.S. Pat. No. 4,654,546. Additionally, it is beneficial to make it swelled in method as is explained in WO publication 96/06718. This dielectric film comprises a permanently charged, biaxially oriented, foamed, typically homogeneous film layer containing flat lens-like, shredded, or cavitated gas bubbles, which may also be referred to as voids or cells. The electret field, or the permanent electric charge, is established by injecting charges into the dielectric material, by applying a very high, in class of 20-25 KV DC charge, on the cellular film, applied against resistive material. The term ‘dielectric cellular electret film’ is employed herein to denote electromechanical films of a generally cellular nature possessing a permanent electric charge.

WO publication 96/06718 outlines a process for pressure inflation of pre-foamed plastic film, enabling the manufacture of highly foamed film products characterized by a substantial foaming degree. These are known as ‘dielectric swelled cellular electret film’ or ‘pressure inflated pre-foamed cellular electret film.’

The method taught by WO publication 96/06718 allows for increasing the thickness of the product without a corresponding increase in the amount of plastic material utilized. An enhancement observed is the increased velocity of gas voids within the film, ranging from 30% to 60% and even up to 70% of the thickness. This improvement leads to an electromechanical response up to 10 times stronger, resulting in a significantly improved signal-to-noise ratio.

The presence of flat lens-like gas bubbles within the electret film effectively impedes the mobility of electret charges within the dielectric material. This is due to the remarkably low electric resistance of gases, which surpasses that of even the most superior solid insulating materials by five orders of magnitude. In contrast to the rigid structure of piezoelectric materials, these gas bubbles serve as an elastic, soft layer during the conversion process—such as transforming string vibrations into electric signals—permitting microscopic changes in thickness induced by pressure variations caused by vibrations.

As the thickness changes, the opposite charges on the opposite sides of the voids either draw closer together or move farther apart, resulting in the generation of so-called mirror charges across the electrodes positioned above the cellular electret film. Consequently, this leads to a measurable electrical output voltage proportional to the force change.

Due the elastic swelled cellular core, the cellular electret film transducer's Young's modulus is significantly reduced, leading to improved impedance matching, particularly with materials like wood, as opposed to hard piezoelectric materials. This results in a cleaner signal output, particularly noticeable in acoustic instruments where it produces a smooth, natural sound.

### SUMMARY OF THE INVENTION

The object of the present invention is that when associated with an acoustical string instrument is to bring the limited spatial range at which the acoustical string instrument can be heard to an audience that is located in a wider spatial range via an amplifier or to record such a sound.

The object of the present invention is to eliminate the drawbacks of prior art pickups, their manufacturing quality, methods and costs, durability for handling the transducer upon its installation, and minimal weight not to affect instruments own sound.

Another objective, regarding embodiments for under-saddle installation, is to create a thin yet soft under-saddle pickup, with electrodes positioned to capture vibrations across the entire width and length of the saddle bottom, rather than just narrowly from the center (in terms of length). This ensures excellent string balance, even when the saddle becomes slightly forward-tilted, as is often the case.

Yet, another object of the invention is to provide a contact pickup having two or more vibrations sensing areas, each of them producing electric signal for enabling sound enhancing separately for each of them, for one or more different strings as a group.

Another object of the invention is to manufacture pickups as simple as possible using material having no separate transducer part and no separately connected conductor or wiring part for connecting it to a signal preamplifier device.

Yet, another object is that the transducer in the pickup has a unitary and flexible construction durable for handling upon installation, is shielded against electromagnetic interference, and produces high signal level.

With the enhanced manufacturing method, it is possible to produce ultra-thin and light, flexible transducers of desired length, width, and shape. Electrodes in the vibrations sensing area, in the active area, extend to the connecting part, and in the end of which, crimped connectors for connecting to a preamplifier are arranged. It has adhesive for attaching it guitar top, to the saddle plate, inside a guitar.

Fabrication is as straight forward as can be imagined, without need to handle many different sheets and do their laminations by hand and sending them between dedicated subcontractors specialized to different aspects of necessary processes. Production is faster and more economic than with conventional methods. This innovation thus allows an effective and economic production technique of transducers based on using electro active film, such as PVDF or charged cellular, swelled ferroelectret film.

A pickup for converting string vibrations from a vibrating musical instrument into electrical signals, the pickup comprising:
a structure, the structure being unitary, flexible, and laminated and extending seamlessly from a transducer through a connector to a contact;
the structure comprising a substrate, the substrate comprising an electromechanical film;
the transducer being printed on the electromechanical film;
the connector being printed on the electromechanical film and operatively connecting the transducer to the contact.

The pickup is modified, wherein the structure has a bilateral form factor having a first side and a second side separated by a fold line.

The pickup is modified, wherein the transducer, connector, and contact, respectively, comprise portions on the first side and the second side.

The pickup is modified, wherein the transducer comprises a signal acquisition area long the longitudinal fold line divided into a first signal acquisition area of the first side and a second signal acquisition area of the second side, each signal acquisition area for acquisition of sound waves and vibrations produced by vibrating musical instrument.

The pickup is modified, wherein the transducer is printed with a silver paste on the electromechanical film.

The pickup is modified, wherein the substrate comprises a lamination structure of polyester (PET) layer defining an outer surface of the substrate sandwiching a biaxially oriented polypropylene (“PP”) film, the PP film being the electromechanical film.

The pickup is modified, wherein each PET layer comprises a thickness of 10-30 microns.

The pickup is modified, wherein the transducer is printed with a highly conductive paste on the electromechanical film and the outer side electrodes comprise printed or taped protection against handling and environmental conditions.

A method of making a pickup or converting string vibrations from a vibrating musical instrument into electrical signals,
the pickup comprising:
a structure, the structure being unitary, flexible, and laminated and extending seamlessly from a transducer through a connector to a contact;
the structure comprising a substrate, the substrate comprising an electromechanical film;
the transducer being printed on the electromechanical film;
the connector being printed on the electromechanical film and operatively connecting the transducer to the contact;
the method comprising the steps of:
(a) using biaxially oriented polypropylene (“PP”) film as an electromechanical film,
(b) subjecting the PP film to AC corona treatment,
(c) subjecting the PP film to swelling, wherein material sensitivity (pC/N) of the PP film is enhanced by undergoing swelling after AC charging and prior to DC charging.

### BRIEF DESCRIPTION OF DRAWINGS

The invention is described in more detail by the aid of examples by referring to the following drawings:

FIG. 1A is an isometric view of a pickup in accordance with one or more embodiments of the presently claimed invention.

FIG. 1B is an isometric view of the pickup of FIG. 1A in an uncrimped status in accordance with one or more embodiments of the presently claimed invention.

FIG. 1C is an isometric view of the pickup of FIGS. 1A and 1B in an unfolded status in accordance with one or more embodiments of the presently claimed invention.

FIG. 1D is an isometric view of the pickup of FIG. 1C in accordance with one or more embodiments of the presently claimed invention.

FIG. 2 is an isometric view of a vibrating musical instrument in the form of a guitar, showing the interior of the guitar and an acoustic guitar saddle plate inside the guitar.

FIG. 3 is an exploded view of a pickup during manufacturing in accordance with one or more embodiments of the presently claimed invention.

FIG. 4 is a plan view of a plurality of transducers and a plurality of connector having respective contacts printed on one side of a sheet in accordance with one or more embodiments of the presently claimed invention.

FIG. 5 is a plan view of a plurality of ground electrode printed on the opposite side of the sheet from the side of the signal electrode.

FIG. 6 is a plan view of the die-cutting blade form, or laser cutting form, for cutting the six pickups of the invention, from a sheet of ferroelectret film, as presented in FIGS. 4 and 5 in accordance with one or more embodiments of the presently claimed invention.

FIG. 7 is schematic diagram of a method of making a dielectric swelled cellular electret film-based pickup in accordance with one or more embodiments of the presently claimed invention.

FIG. 8a is a plan view of an under saddle pickup type, completely folded along perforations, without crimped connectors.

FIG. 8b is sectional axonometric view of the pickup of FIG. 8a.

FIG. 9a shows the pickup of FIG. 8a but directly from above.

FIG. 9b shows section of the pickup of FIG. 9a.

FIG. 10a is a plan view of eight pickups printed signal electrodes of the embodiment of the innovation as shown in FIGS. 8a-9a.

FIGS. 10b-10d are detailed views of the signal electrodes of FIG. 10a.

FIG. 11 is the same under-saddle embodiment as exploded view.

FIG. 12 is a closeup view of the undersaddle coming area.

### DETAILED DESCRIPTION OF THE INVENTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

All technical and scientific terms shall have the same meaning as commonly understood by one of ordinary skill in the art. Nonetheless, certain terms are defined herein to aid in the understanding of the disclosure; these definitions apply to all parts of speech of the term regardless whether the term is defined explicitly as such.

### Definitions

All definitions are given in the singular, but are similarly applicable in the plural.

The term “transducer” is used for a physical electromechanical element that converts vibrations to an electrical sensor. A transducer preferably comprises an electret or ferroelectret material.

The term “pickup” is used for an object having a form factor suitable for the musical instrument with which it is associated and includes at least one transducer. More often the pickup also includes one or more connectors having one or more contacts (for example, a plug type connector) to another object (for example, a cable to an amplifier) and one or more leads (for example, a wire bond) from the transducer to the respective connector.

“Electret,” or in accordance with one or more embodiments of the presently claimed invention “ferroelectret,” refers to a dielectric material that has an essentially permanent electrical polarization. “Ferroelectret” is sometimes spelled “ferro-electret,” and such spelling should be considered reasonably similar for the purposes of this invention.

The terms “dielectric swelled cellular electret film” or “pressure inflated pre-foamed cellular electret film” are employed herein to denote a foamed plastic product, as described in WO publication 96/06718 or its equivalent U.S. Pat. No. 5,955,014 A, which is permanently charged under a strong electric field, achieved through the injection of electric charge into the material. U.S. Pat. No. 5,955,014 A is hereby incorporated by reference in its entirety for all purposes.

In contrast, the term “dielectric cellular electret film” is employed herein to denote electromechanical films of a generally cellular nature possessing a permanent electric charge without foaming.

An “electromechanical film” denotes a film has an electromechanical element and which may be electrotet film.

The term “vibrating musical instrument” or its abbreviation “VMI” refers to instruments that have a vibrating element that is not a reed or reed instruments. A VMI may be an acoustic musical string instrument such as a guitar, ukulele, violin, and/or bass, wherein one or more strings vibrate to create an intended musical sound when played by a musician.

The definition of VMI also includes percussion instruments such as a drum set, a tambourine, a cajon (a box shaped percussion instrument), a membranophone, an idiophone, and/or combinations thereof wherein vibration is produced from a surface, such as a drum skin (also call a drum head) produces an intended musical sound when played by a musician.

The lists for VMI are only exemplary and are not intended to be exhaustive since the variety and ingenuity of making music leads to many new and interesting stringed and percussion instruments.

The term “musician” defines a user of the present invention, whether that user is skilled or unskilled, but preferably human.

### Pickup

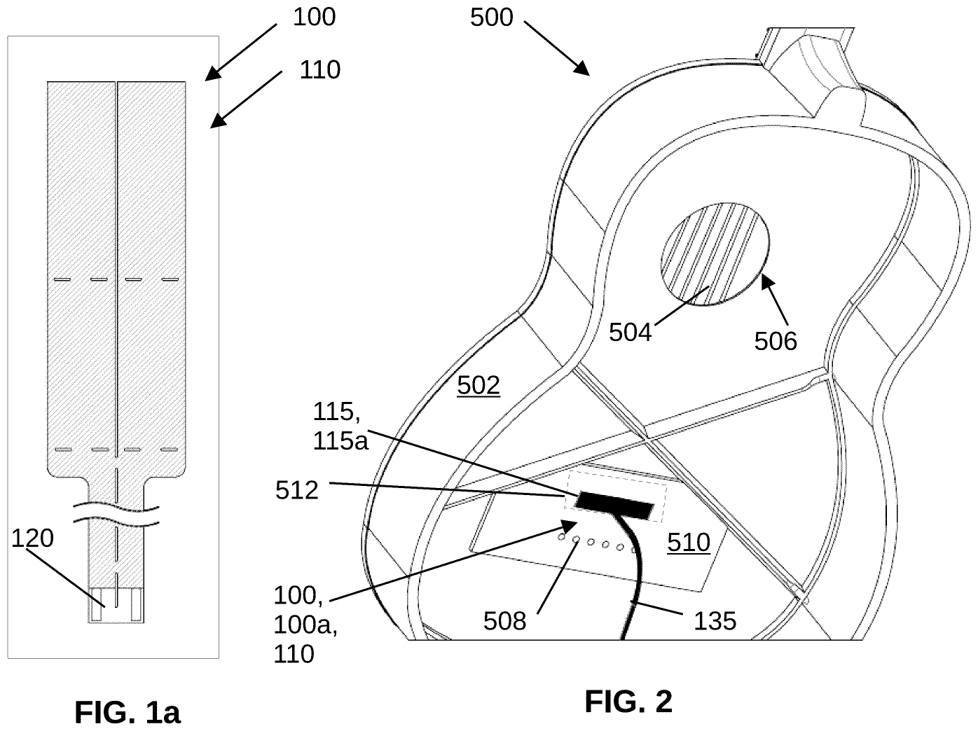

FIG. 1A is an isometric view of a pickup in accordance with one or more embodiments of the presently claimed invention.

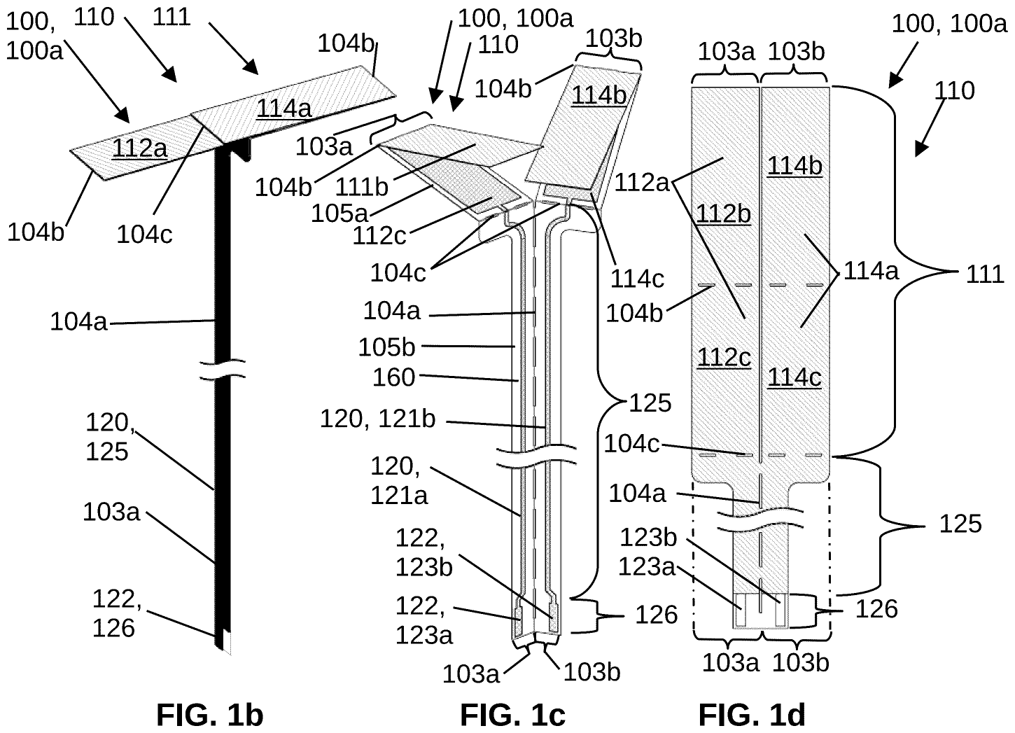

FIG. 2 is an isometric view of a vibrating musical instrument in the form of a guitar, showing the interior of the guitar and an acoustic guitar saddle plate inside the guitar.

Referring to FIGS. 1a and 2, in accordance with one or more embodiments of the presently claimed invention, a pickup 100 is associated with a vibrating musical instrument 500 and is used to convert one or more vibrations of to one or more electrical signals. The signals are preferably transmitted via a connector part 135 (shown in FIG. 2) to a preamplifier (not shown) for receiving the one or more electrical signals by the preamplifier to be played to an audience of listeners for their enjoyment. For ease of illustration of FIG. 2, vibrating musical instrument 500 is depicted as an acoustical guitar and pickup 100 is mounted inside the body of the guitar as an illustration of one association of pickup 100 with vibrating musical instrument 500.

Pickup 100 comprises a transducer 110 for converting one or more vibrations of a vibrating musical instrument 500 (depicted for ease of illustration as an acoustical guitar) to one or more electrical signals and a connector 120 for operatively connecting pickup 100 to a preamplifier (not shown) for receiving the one or more electrical signals.

Pickup 100 may have any suitable shape, form, or form factor, but preferably has a shape that consists of the shape of transducer 110 and the shape of connector 120. However, other shapes may also be suitable for a variety of reasons, not least of all for commercial purposes of making the product able to be easily handled by a user.

As shown in FIG. 2, pickup 100 is used with vibrating musical instrument 500 illustrated as an acoustical musical string instrument. Vibrating musical instrument 500 has a body 502 (the rear of the body has been omitted for purposes of illustration), at least one musical string 504 (six (6) strings are shown for purposes of illustration) viewable through acoustic opening 506, and fasteners 508 disposed on a saddle plate 510. Fasteners 508 herein define the location of a saddle on the opposite side of the body (hence not shown), also known as a bridge, over which the at least one musical string 504 is raised from the body to allow a musician to play, i.e. manipulate, the strings.

Referring again to FIG. 2, pickup 100 is secured to saddle plate 510, which is a vibrating member of vibrating musical instrument 500. Musicians refer to the area of the saddle and forward of it, or to the saddle plate as the saddle area and is defined using dashed lines forming a rectangle. The saddle area is an example of the musician preferred location 512. That is, in this example, the saddle area corresponds to what is referred to herein as the musician preferred location 512. The musician preferred location 512 is defined as producing the reliably strongest vibrations from the vibrating musical instrument and results correspondingly in the strongest electrical signals from the transducer 110.

The musician preferred location 512 can also be defined as producing the reliably strongest vibrations from the vibrating musical instrument and results correspondingly in the strongest electrical signals from the transducer 110 wherein pickup 500 is not visible since it is hidden in the acoustic cavity of the vibrating musical instrument.

In other vibrating musical instruments, the musician preferred location 512 may be different. Therein, the musician preferred location 512 is defined as producing the strongest vibrations from the vibrating musical instrument and resulting correspondingly in the strongest electrical signals from the transducer 110 without pickup 500 being visible, without obtrusive, and/or without requiring one or more of the following: removal, reconstruction, and/or alteration of the vibrating musical instrument.

In accordance with one or more embodiments of the presently claimed invention, as a secondary choice and not meeting the musician preferred location standards, pickups can alternatively be positioned between the saddle and the saddle slot for alternative pickup configurations.

Pickup 100 is attached to vibrating musical instrument 500 by using any suitable means. In accordance with one or more embodiments of the presently claimed invention, pickup 100 is preferably attached using an adhesive tab 165, for example an acrylic adhesive 50 microns in thickness. Such an adhesive is made in accordance with one or more embodiments by 3M®.

In accordance with one or more embodiments of the presently claimed invention, by attaching pickup 100 using an adhesive, pickup 100 is specific type of pickup, a contact pickup 100a. In the context of the specific embodiment of an acoustical guitar in FIG. 2, pickup 100a is an acoustic guitar contact pickup affixed with adhesive onto the guitar top beneath the saddle area.

Herein, a contact pickup 100a, i. e. a pickup that converts vibrations from both the strings and the wooden top into electrical signals. In accordance with one or more embodiments of the presently claimed invention, contact pickups comprise a transducer 110, which in turn comprises one or more layers of electromechanical transducer materials.

FIG. 1B is an isometric view of the pickup of FIG. 1A in an uncrimped status in accordance with one or more embodiments of the presently claimed invention.

FIG. 1C is an isometric view of the pickup of FIGS. 1A and 1B in an unfolded status in accordance with one or more embodiments of the presently claimed invention.

FIG. 1D is an isometric view of the pickup of FIG. 1C in accordance with one or more embodiments of the presently claimed invention.

FIGS. 1B-1D, in that order, show the pickup after various manufacturing stages in reverse order, from complex to more simple. That is, FIG. 1D is actually a pickup after a prior manufacturing step to FIG. 1C, and FIG. 1C is a pickup after a prior manufacturing step to FIG. 1B. FIG. 1C comprises a protective layer 160, but the protective layer 160 is not shown in FIGS. 1B and 1D for clarity of illustration.

Pickup 100 comprises an electromechanical film 150 which in accordance with one or more embodiments is in the form of an electret film. Thus, advantageously, pickup 100 is realized as a unitary, flexible, and laminated structure that extends seamlessly from a transducer 110 through a connector 120 including to a contact 122. Herein, an electret film 150 may also be electromechanical film 150 unless the particular qualities of an electret film are advantageous, needed, or required.

When manufactured, pickup 100 comprises a transducer 110 and a connector 120 for operatively connecting transducer 110 via one or more contacts 122 of connector 120.

Therein, pickup 100 is advantageously formed as a bilateral structure 102 having a first side 103a (shown herein as the left side) and a second side 103b (shown herein as the right side) that are separated by a longitudinal fold line 104a. Portions of each of transducer 110, connector 120, and contact 122 are disposed on each side 103a, 103b and joined by the manufacturing process to form the respective transducer 110, connector 120, and contact 122.

Advantageously, pickup 100 does not require a mechanically separate transducer and a distinct wiring between the transducer and one or more contacts since transducer 110 will be printed on an electret film 150, which is used as a substrate.

Transducer 110 comprises a signal acquisition area 111 divided along fold line 104a into a first signal acquisition area 112a of first side 103a and a second signal acquisition area 114a of second side 103b. Each signal acquisition area 112a and 114a for acquisition of sound waves and vibrations produced by vibrating musical instrument 500.

Signal acquisition area 111 may be any suitable shape, but preferably is rectangular in shape matching electret film 150, which is used as substrate in the manufacturing process.

Transducer 110 comprises a first pickup area 112 of first sensing area 111a and a second pickup area 114a disposed in second sensing area 111b that are shown as left and right in FIGS. 1B-1D.

Each of first signal acquisition areas 112a and second signal acquisition area 114b are preferably subdivided into two respective and interoperable regions 112b, 112c, 114b, and 114c, respectively, preferably but not necessarily along a transverse fold line 104b of the manufacturing process.

A connector 120 comprises a first connector portion 121a on first side 103a and a second connector portion 121b in second side 103b and a contact 122 comprising first contact portion 123a in first side 103 and a second contact portion 123b in second side 103b. Connector portions 121a, 121b and connector portions 123a, 123b are joined by the manufacturing process to form the connector 120 and contact 122.

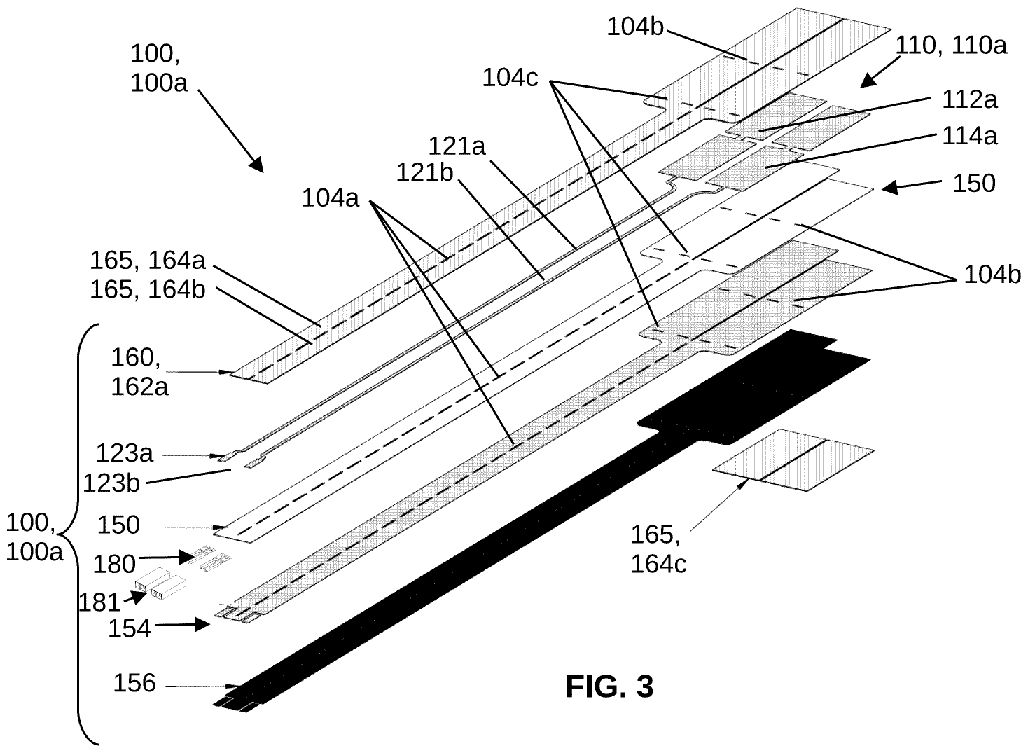

Connector 120 is disposed in a connector region 125 and contact 122 in contact region 126, for operatively linking transducer 110 to a signal processing device, such as a preamplifier (not shown). One or more connector components on the preamplifier may in accordance with one or more embodiments be a Zero Insertion Force (ZIF) type, advantageously negating the need for crimped contacts. In FIG. 3 crimped contacts 180 and their plastic shell 181 for plugging a pickup onto a pin-header are shown.

In accordance with one or more embodiments of the presently claimed invention, as shown in FIG. 1C, one or more margins 105a are disposed between an edge of a film 150 and first pickup area 112a and/or second pickup area 114a and/or one or more margins 105b re disposed between an edge of an electret film 150 and first connector 123a and second connector 123b for ease of manufacturing.

Therein, one or more margins 105a and one or more margins 105b are preferably at least 1 mm to prevent 50 Hz/60 Hz electromagnetic noise (hum) from entering the picked signal for amplification.

FIG. 3 is an exploded view of a pickup during manufacturing in accordance with one or more embodiments of the presently claimed invention.

Pickup 100 comprises a plurality of layers including an outer layer 160, which comprises a protective paper layer 162 and an adhesive 165, more specifically, an adhesive layer 164a in first side 103a and adhesive layer 164b in second side 103b with protective paper layer 162 are applied in step 715.

Transducer 110 is disposed as a layer between outer layer 160 and electret film 150 on which transducer 110 is printed. Electret film 150 may be laminated PET-PP-PET.

A ground electrode 154 is disposed on electret film 150 and a graphite layer 156 is disposed facing ground electrode 154.

An adhesive layer 164c preferably comprising adhesive 165 is disposed on a reverse side of ground electrode 156. Adhesive layer 164c covers only the area necessary to facilitate a secure attachment to vibrating musical instrument 500 when the pickup is folded for use.

Therein, adhesive layers 164a, 164b, and/or 164c are preferably of a thickness between 20-100 microns. However, in accordance with one or more embodiments of the presently claimed invention, the thickness of the adhesive 50 microns is a very good choice because of its ready availability.

Adhesive tab 165 comprises adhesive 164c and a protective paper over the adhesive. Adhesive tab 165 is used for attaching the pickup to the guitar saddle plate by folding the adhesive tab in half to secure the first half of the adhesive side to pickup 100 and the other half to the vibrating musical instrument 500 at musician preferred location 512.

An example of a suitable adhesive is the 50-micron acrylic adhesive from 3M or Nitto. Since the electrodes are printed directly onto the PET layers, the adhesive thickness does not reduce signal strength and increase noise, as has been the case with prior art ferroelectret pickups, as explained in patents such as U.S. Pat. Nos. 6,242,683 and 6,336,367.

### Method of Manufacturing Dielectric Swelled Cellular Electret Film-Based Pickup

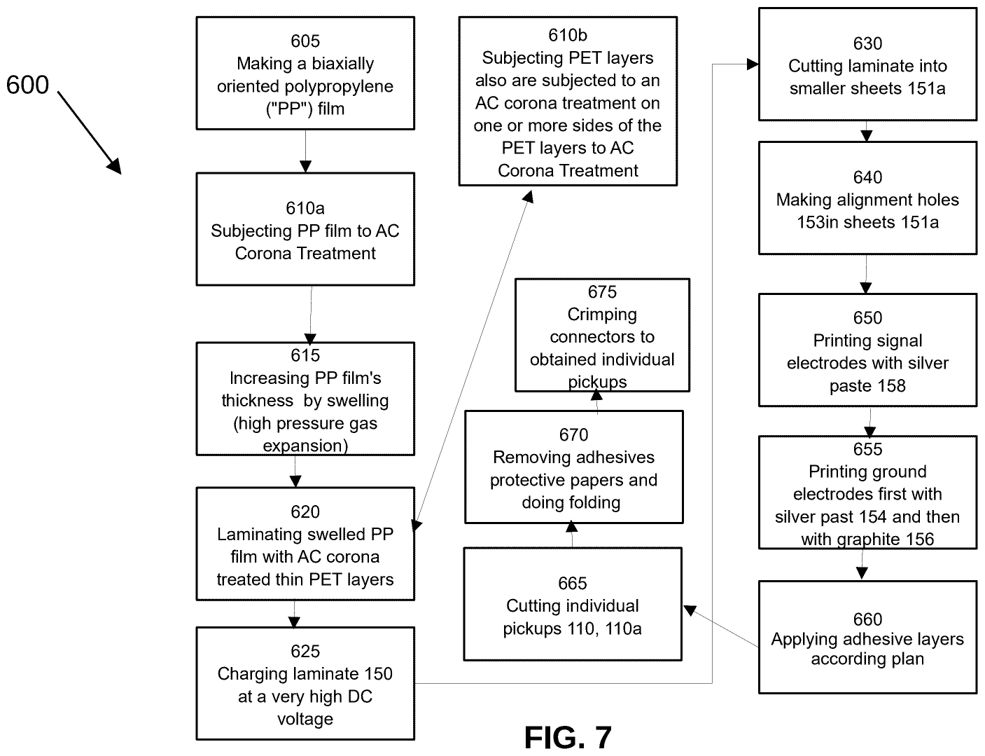

FIG. 7 is schematic diagram of a method 600 of making a dielectric swelled cellular electret film-based pickup 100a in accordance with one or more embodiments of the presently claimed invention.

In accordance with one or more embodiments of the presently claimed invention, a method 600 is a method of making a dielectric swelled cellular electret film-based pickup 100a.

In a first step 605, a biaxially oriented polypropylene (“PP”) film is manufactured for this purpose or provided thereto and used as a PP electret film 150a for a transducer 110a. Therein, pickup 100a and transducer 110a are identical to pickup 100 and transducer 110, respectively, taught herein with the exception that electret film 150 is a PP electret film 150a.

The method of manufacturing of PP electret film 150a is disclosed, for example, in U.S. Pat. No. 4,654,546, which is hereby incorporated by reference in its entirety for all purposes.

Alternately, PP electret film 150a for transducer 110a is purchased, acquired, or provided as necessary by a user or other person associated with method 600.

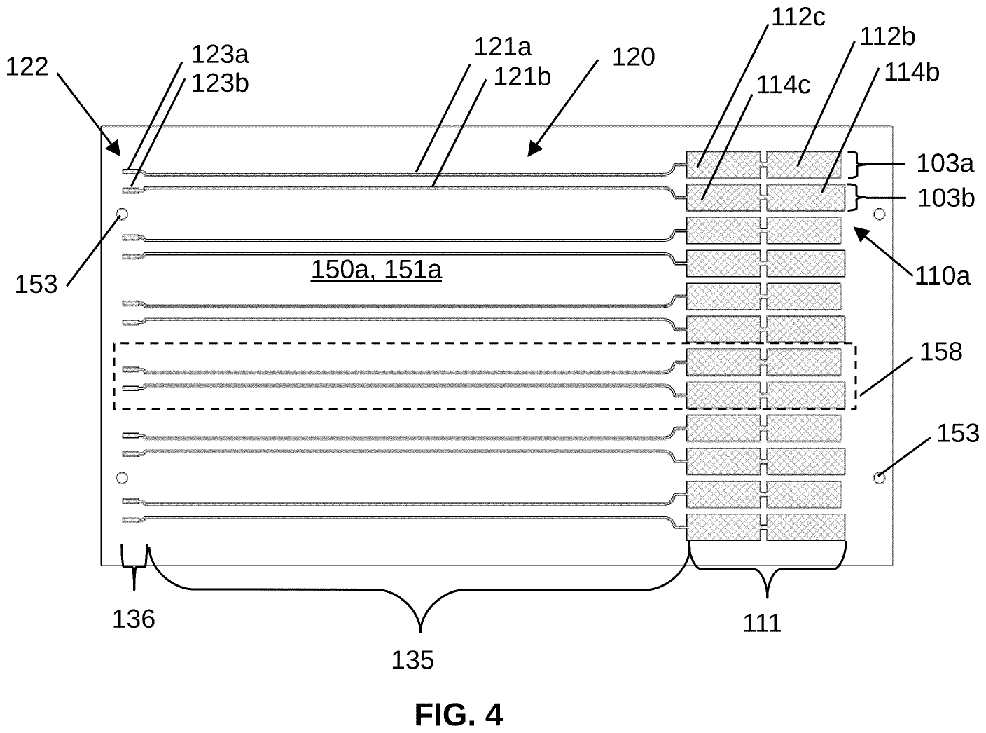

Therein, PP electret film 150a will be larger than is necessary to make pickup 100a and in a subsequent step 630 will be reduced in size. A sheet (not shown, but a smaller reduced size sheet 151a of step 630 is shown) of PP electret file 150a may be used to make a plurality of pickups 100a, as illustrated with reference to FIG. 4.

In a subsequent step 610a, the PP film is subjected to AC corona treatment. The AC corona treatment is necessary for the purpose of making one or more PP film surfaces beneficial for lamination with PET layers in a subsequent step. The AC corona treatment gives one or more the PP film surface a treatment that improves the adhesive bonding of the PET layers and the PP film, i.e. PP film surface.

In a step 610b, the PET layers also are subjected to an AC corona treatment on one or more sides of the PET layers, or preferably on both sides of the PET layer, for improved adhesion between swelled PP film and for the silver paste.

In a subsequent step 615 directed broadly to swelling, the material's sensitivity (pC/N) is enhanced by undergoing swelling after AC charging and prior to DC charging. This is explained in WO publication 96/06718 or its equivalent U.S. Pat. No. 5,955,014. U.S. Pat. No. 5,955,014 is hereby incorporated by reference in its entirety for all purposes.

During swelling of step 615, the PP film's thickness is increased by increasing the height of cavities. Therein, advantageously, the weight remains the same but thickness increases. This gives more sensitivity when charged for having permanent electric charge.

As previously taught, as the thickness changes, the opposite charges on the opposite sides of the voids either draw closer together or move farther apart, resulting in the generation of so-called mirror charges across the electrodes positioned above the cellular electret film. Consequently, this leads to a measurable electrical output voltage proportional to the force change.

Therein, the charged material PP electret film 150a produces positive and negative charges on opposite sides. Thus, usually signal electrodes are printed on the positive side and ground on the negative sides but these can be arranged also on opposite manners

Due the elastic swelled cellular core, the Young's modulus of cellular electret film transducer 110a is significantly reduced, leading to improved impedance matching, particularly with materials like wood, as opposed to hard piezoelectric materials. This results in a cleaner signal output, particularly noticeable in acoustic instruments where it produces a smooth, natural sound.

In a subsequent step 620 directed broadly to lamination, following the swelling, to prevent shrinkage during subsequent silver paste curing, preferably a 23-micron-thin polyester (PET) layer, but can be thinner or slightly thicker, is laminated onto both sides of the electret film in a reel-to-reel process preferably using the wet gluing method. The PET is preferred to be heat treated to prevent its shrinking during silver paste curing.

Advantageously, the thin PET film on both sides of core's cellular PP film enables the direct printing of transducer 110 and connector 120 including contact 122 in a later step 650 onto the resulting laminate where the cellular, swelled ferroelectret film forms the core. Herein, the core is the material in the laminate that gets charged in high DC field and where discharges occur in the core's lens like gas bubbles (cavities) during DC charging.

Advantageously, a thin PET layer of 10-30 microns does not significantly increase thickness. Excessive thickness of PET layers in the laminate would decrease the sensitivity of the achieved electromechanical films, i.e., the charge output from vibrations it is intended for in a guitar. Herein, in accordance with one or more embodiments of the invention, an excessive thickness of a PET layer is defined as 25 microns or more. In accordance with one or more embodiments of the invention, an excessive thickness of a PET layer is defined as 30 microns or more. That is, advantageously, in accordance with one or more embodiments of the presently claimed invention, the thickness is kept at a minimum, the mirror charges across the electrodes positioned above the cellular electret film are kept at a minimum or eliminated entirely.

In step 620, instead of polyester (PET) many other plastics can be used. Therein, polyamide is a substitute. However, PET is the most cost effective and more cost effective than polyamide, easily available and has excellent purpose-directed properties. Purpose-directed properties are defined herein as being the property of being heat treatable for becoming non-shrinking and the property of having, after corona treatment, good adhesion with silver paste.

Utilizing a very thin wet adhesive in a reel-to-reel lamination process, with an end thickness in the range of 10-20 microns after curing, helps to minimize overall thickness and weight, and achieve the best properties for an acoustic guitar pickup or any other application such as a contact microphone. Advantageously, the thinner PET with adhesive layers, between later explained electrodes and core's cellular PP film, yields higher output, as the thicker the entire structure between signal and ground electrodes, the lower the output of such ferroelectrets.

The laminated (PET-PP-PET) structure, the PET being heat treated in beforehand, of laminate does not shrink during the approximately 80° C. curing required for the silver paste and graphite layers needed for electrodes, as explained later. Preferably, such a laminated structure facilitates the creation of a structure where electrodes printed on both side surfaces can be perfectly aligned before cutting into individual pickups.

Following the lamination process of step 620, in a step 625, the obtained PET-PP-PET material, i.e. laminate 150 is charged at a very high DC voltage, typically in the range of 20-25 kV, against resistive material. In accordance with one or more embodiments of the present invention, DC charging could be performed prior to laminating with PET layers.

In accordance with one or more embodiments of the present invention, the cellular ferroelectret film is charged in step 625 after it is laminated with PET films. The sequence of step 620 followed by step 625 helps prevent discharges when a charged material is rolled into an end-roll in the final phase of reel-to-reel charging. It is also possible to charge this laminated material in sheets, but it is slower, resulting in increased manufacturing costs. Step 625 of charging, however, must be completed before printing the electrodes in a step 650.

When the laminated (PET-PP-PET) ferroelectret material is charged, it is preferably cut into smaller sheets 151a in a step 630 of broadly cutting. In accordance with one or more embodiments of the presently claimed invention, six transducers 110 are cut from one sheet, for screen printing the electrodes in step 650.

After step 630 of cutting onto smaller sheet 151a to obtain preferred quantity of pickups, the sheet is prepared for high precision printing in a step 640 by making one or more alignment holes 153 in sheet 151a. Hole cutting in the sheets can be done by laser cutting or die-cutting.

After obtaining sheets 151a, if not already present one or more alignment holes 153 are made through sheet 151a to prevent unintended displacement of sheet 151a during printing of signal electrodes 158 or ground electrodes 154 or proper alignment during printing of the electrodes 158, 154.

FIG. 4 is a plan view of a plurality of transducers 110a and a plurality of connector 120 having respective contacts 122 printed on one side of a sheet 151 in accordance with one or more embodiments of the presently claimed invention.

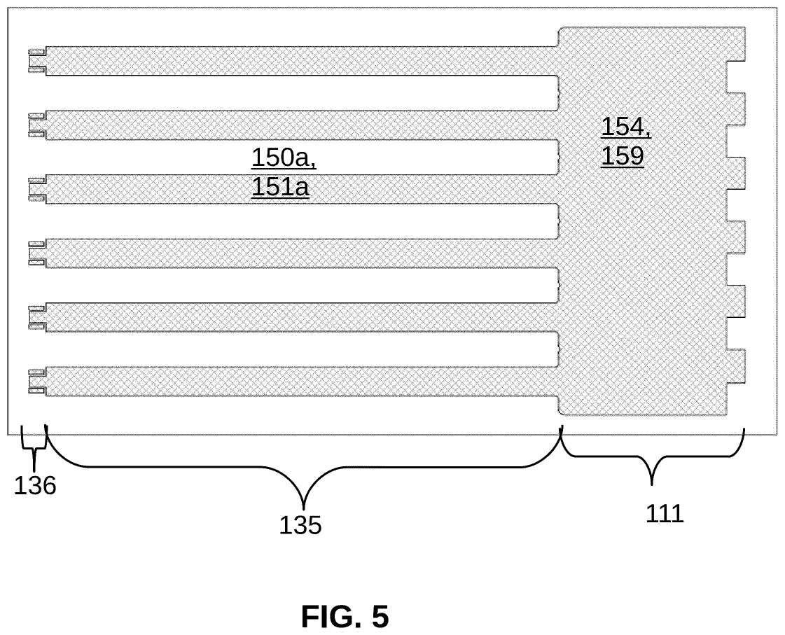

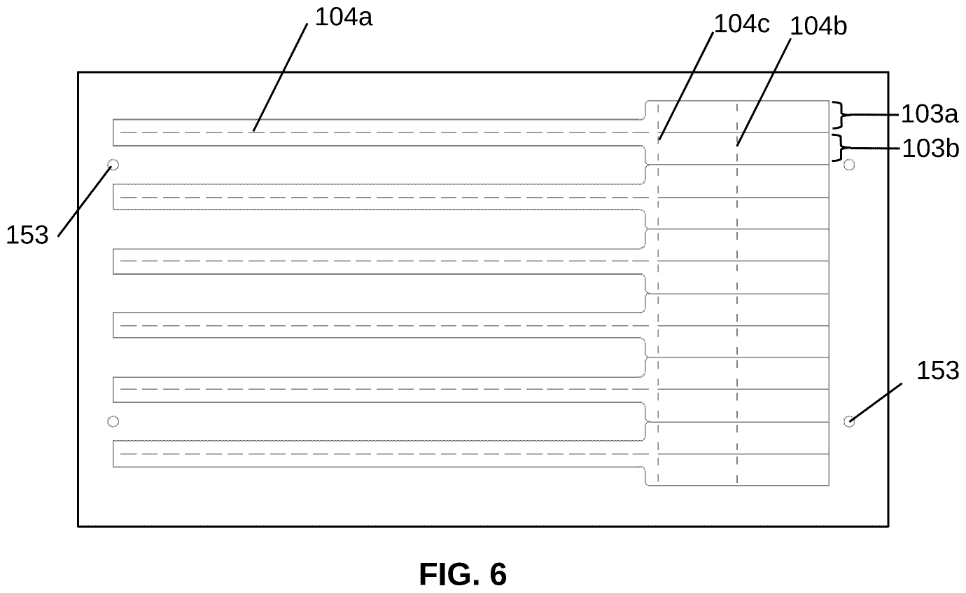

FIG. 5 is a plan view of a plurality of ground electrode 154 printed on the opposite side of sheet 151 from the side of the signal electrode 158.

In a step 650, signal electrodes 158 comprising transducers 110b and a plurality of connector 120 having respective contacts 122 are directly printed on sheet 151 using sheet printing utilizing alignment holes 153 for precise alignment of sheet 151.

Instead of sheet printing, signal electrodes 158 can be screen-printed reel-to-reel on PP electret film 150a. However, sheet printing has a higher accuracy than reel-to-reel printing where accuracy is more difficult to obtain due to the speed of the reel.

In subsequent step 655, the ground electrodes 154 are printed preferably with silver paste 159 and then after curing of the silver paste 159, in a step 660, the same design is printed with graphite as a graphite layer 156. Since graphite serves as the outer face in the final product, this protection is necessary for durablity of pickup 110a.

Graphite possesses excellent resistance to handling and abrasion, and unlike silver, it does not oxidize. Instead of printing graphite for silver paste protection also a very thin glued plastic sheet or printed insulate could be used. Both printed layers are printed exactly on the correct place using alignment holes 153.

In step 660 adhesive layers are applied according plan.

In a step 665, sheet 151 printed with signal electrodes 158 on side and ground electrodes 154 and graphite layer 159 on the other side, and adhesive layers and their protective papers covering planned areas, are cut final individual pickups 100a. This can be achieved through die-cutting or laser cutting. Preferably, alignment holes 153 are utilized to more accurately make the cuts.

Innovative new method is the use of perforations (106, 117) that enable folding the pickup like origami in the final state before crimping contacts. One perforation (106) is longitudinal and other is crosswise compared to it. Depending on preferences, it is possible to have only longitudinal or only cross wise perforation, one or more, to enable folding and forming shield against EMI (electromagnetic interference, the 50 or 60 Hz hum). After cutting, individual pickups are obtained as shown in FIG. 3. The image depicts a pickup from the signal electrode (102) side.

FIGS. 1a-1d represents a pickup to the one in FIG. 2, but during the initial stages of folding. At this point, the protective paper (116) covering the adhesive layer (115) has already been removed. In the pickup production method of the innovation, the perforations (106, 117) obtained during cutting, facilitate the final folding process to create completed pickups ready for attaching connectors.

Instead of dielectric swelled cellular electret film such as PET-PP-PET DC charged ferroelectret material 110a, transducer 110 of pickup 100 may comprise a piezoelectric PVDF material.

However, one skilled in the art will recognize that listeners are often of the opinion that a piezoelectric PVDF material does not produce high fidelity sound characteristics and one skilled in the art would understand the piezoelectric PVDF material is more expensive to manufacture and its raw material costs are higher.

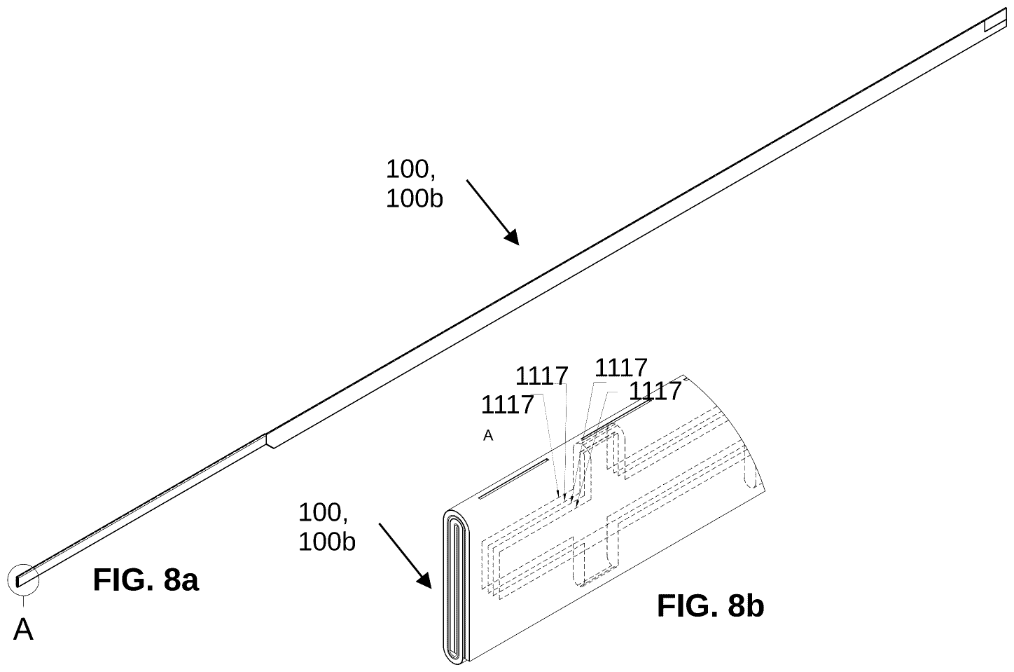

FIG. 8a shows another embodiment of the innovation, an under saddle pickup type 100b, completely folded along perforations, without crimped connectors. A sectional axonometric drawing of it is FIG. 8b.

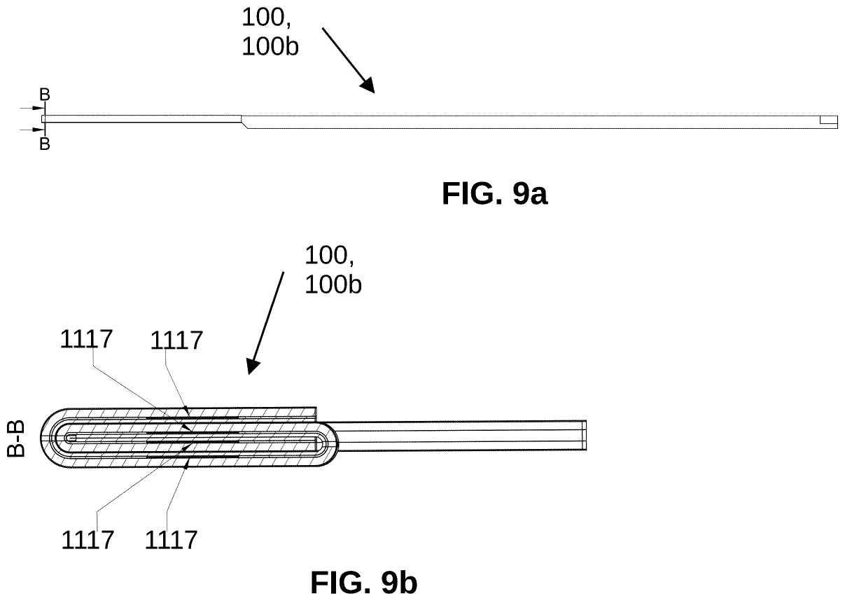

FIG. 9a shows the same as in FIG. 8a but directly from above. FIG. 9b shows section of it. It shows how the active area that goes under saddle is rolled and form four layers that all produce sound from string vibrations via the saddle between them and the pickup.

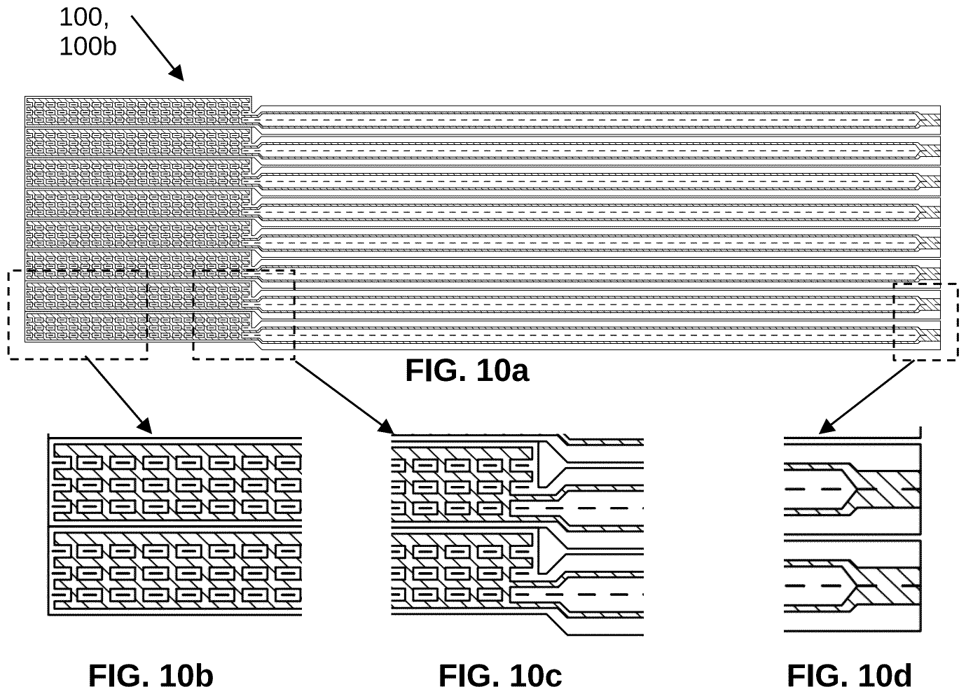

FIG. 10 illustrates eight pickups having printed signal electrodes of the embodiment of the innovation of pickup 100b. Same as in FIGS. 8a-9a, which intended for saddle slot ie. under saddle installation, Picture is after laser or die-cutting and release paper of the adhesive is removed but pickups and picturized for clarity next to each other. One can imagine how ground electrodes are printed on the opposite side.

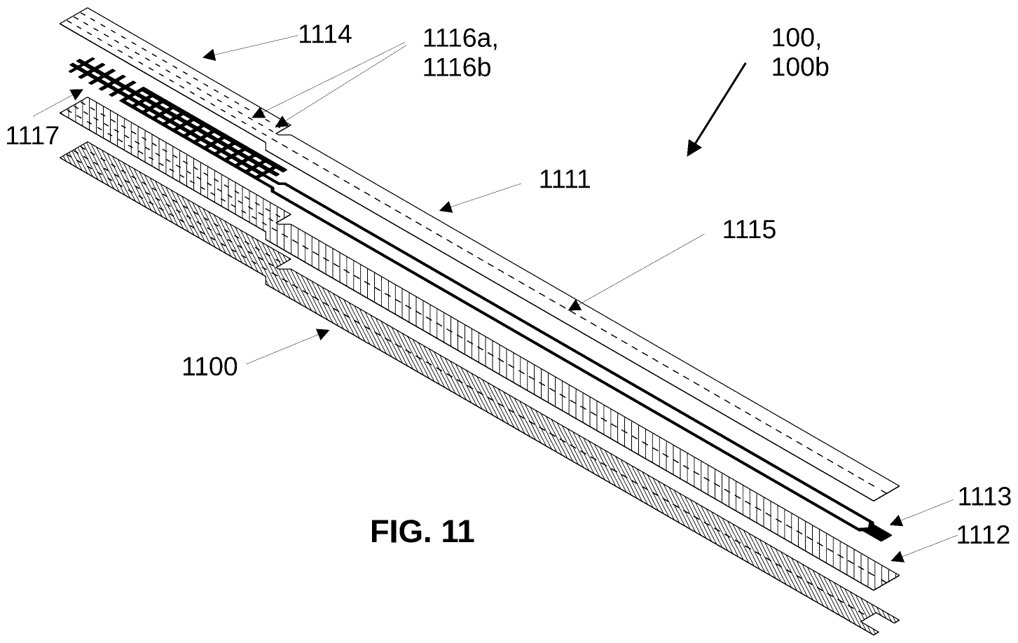

FIG. 11 shows the same under-saddle embodiment 100b as exploded view. The 1100 shows ground electrode, first it is printed with silver paste and in addition on it by graphite. The 1111 indicates the adhesive layer for fixing surfaces together at folding. This embodiment needs to have special adhesive where there is a very thin PET layer in the center and acrylic adhesives are on both sides, for example from Nitto. There are very thin ones, even 10 and 30 microns as total thickness, but also 50 microns. All can be used. The PET layer in its core will prevent shorts between signal electrode 1113 and ground electrode 11000 after “rolling” the active area together. In FIG. 11 the swelled and charged ferroelectret layer is the 1112. This embodiment has one perforation 1115 that goes through the entire length. In addition there are two more same direction going perforation lines 1116a and 1116b. These enable that the active area becoming in the installation into the saddle slot, will get altogether four active layers enabled by this manufacturing method. It would produce sound already with just two layers, and more with three, but best optimization between total thickness, that for more natural sound should be kept thin, and great string to string balance is good with four layers. Five or even more technically possible but unnecessary.

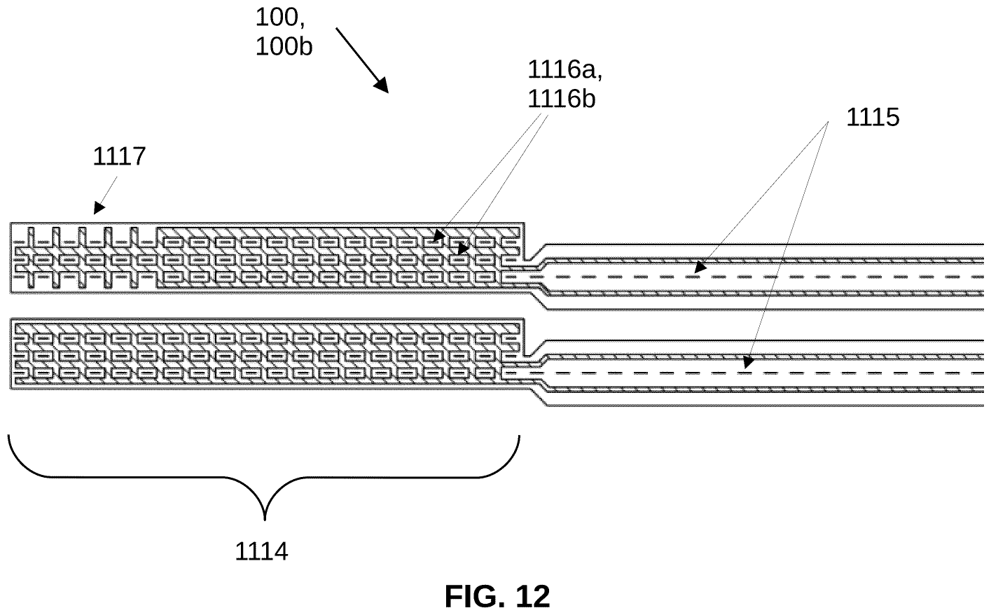

FIG. 12 is more closeup of the undersaddle coming area 1114. It also shows in some guitars necessary sound volume compensation 1117 for two highest vibrating strings, that in many would produce more dB ie. stronger volume, which often is unwanted. As the signal electrode area can be reduced, it reduces output from those two strings.

It is evident to those skilled in the art that various embodiments of the invention are not limited to the examples outlined above, but rather can be modified within the scope of the claims provided below. The form (shape) can be selected based on the requirements of each specific case; there can be multiple transducer areas, and the shape of the area can vary beyond a rectangular form in the top view. These transducers have versatile applications, including their use as transducers in musical instruments.

While the invention has been described in conjunction with specific embodiments, it is to be understood that many alternatives, modifications, and variations will be apparent to those skilled in the art in light of the foregoing description.

1. A pickup for converting string vibrations from a vibrating musical instrument into electrical signals, the pickup comprising:
a structure, the structure being unitary, flexible, and laminated and extending seamlessly from a transducer through a connector to a contact;
the structure comprising a substrate, the substrate comprising an electromechanical film;
the transducer being printed on the electromechanical film;
the connector being printed on the electromechanical film and operatively connecting the transducer to the contact.

2. The pickup of claim 1, wherein the structure has a bilateral form factor having a first side and a second side separated by a fold line.

3. The pickup of claim 2, wherein the transducer, connector, and contact, respectively, comprise portions on the first side and the second side.

4. The pickup of claim 3, wherein the transducer comprises a signal acquisition area long the longitudinal fold line divided into a first signal acquisition area of the first side and a second signal acquisition area of the second side, each signal acquisition area for acquisition of sound waves and vibrations produced by vibrating musical instrument.

5. The pickup of claim 4, wherein the transducer is printed with a silver paste on the electromechanical film.

6. The pickup of claim 1, wherein the substrate comprises a lamination structure of polyester (PET) layer defining an outer surface of the substrate sandwiching a biaxially oriented polypropylene (“PP”) film, the PP film being the electromechanical film.

7. The pickup of claim 6, wherein each PET layer comprises a thickness of 10-30 microns.

8. The pickup of claim 1, wherein the transducer is printed with a highly conductive paste on the electromechanical film and the outer side electrodes comprise printed or taped protection against handling and environmental conditions.

9. A method of making a pickup or converting string vibrations from a vibrating musical instrument into electrical signals,
the pickup comprising:
a structure, the structure being unitary, flexible, and laminated and extending seamlessly from a transducer through a connector to a contact;
the structure comprising a substrate, the substrate comprising an electromechanical film;
the transducer being printed on the electromechanical film;
the connector being printed on the electromechanical film and operatively connecting the transducer to the contact;
the method comprising the steps of:
(a) using biaxially oriented polypropylene (“PP”) film as an electromechanical film,
(b) subjecting the PP film to AC corona treatment,
(c) subjecting the PP film to swelling, wherein material sensitivity (pC/N) of the PP film is enhanced by undergoing swelling after AC charging and prior to DC charging.
